(19) United States
(12) Patent Application Publication
(10) Pub. No.: US 2024/0350995 A1
(43) Pub. Date: Oct. 24, 2024

(54) RENEWABLE FUEL SYNTHESIS SYSTEM AND METHOD

(71) Applicant: METHYLENNIUM ENERGY CORP., Falls Church, VA (US)

(72) Inventors: Maxim LYUBOVSKY, Fairfax, VA (US); John REARDON, Chesterfield, MO (US)

(21) Appl. No.: 18/640,800

(22) Filed: Apr. 19, 2024

Related U.S. Application Data
(60) Provisional application No. 63/461,524, filed on Apr. 24, 2023.

(51) Int. Cl. B01J 8/00; C10L 3/08

(52) U.S. Cl. CPC B01J 8/008; C10L 3/08; B01J 2208/00106; B01J 2208/00504; B01J 2208/00893

(57) ABSTRACT

Systems and methods for producing fuel products from renewable energy sources are disclosed herein. A reactor system includes a variable feed of non-combustible gas, a hydrogen gas buffer providing a variable feed of hydrogen gas, a reactor coupled to the variable feeds and configured to convert the non-combustible gas and the hydrogen gas into a renewable fuel product, a heat exchanger coupled to an outlet of the reactor, a phase separator coupled to an outlet of the heat exchanger and configured to separate a gas stream including un-reacted hydrogen and un-reacted non-combustible gas from a liquid stream including the renewable fuel product, and a burner configured to combust the un-reacted hydrogen contained in the gas stream. The reactor includes an internal heat exchanger configured to provide cooling to the reactor in a normal operating mode and to provide heating to the reactor in an idle mode.

### CROSS-REFERENCE TO RELATED APPLICATION(S)

This application claims priority to U.S. Patent Application No. 63/461,524, filed 24 Apr. 2023, and entitled “Method for Dynamic Operation of a Renewable Fuel Synthesis System,” the entire disclosure of which is hereby incorporated by reference in its entirety.

### FIELD

The described embodiments relate generally to renewable fuels, and more particularly, to a renewable fuel synthesis system and a method of dynamic operation thereof that produces renewable fuels from a reaction of a non-combustible gas with hydrogen.

### BACKGROUND

Over the past century, transportation technologies have evolved around the use of liquid hydrocarbon fuels produced primarily from fossil oil and gas. Due to the finite nature of fossil reserves and the rapidly increasing concentration of carbon dioxide in the atmosphere, there is a growing public concern with continued reliance on fossil oil and gas as a source of fuels. Thus, there is an increasing interest in switching to using renewable energy sources, such as solar and wind energy. Renewable energy sources can be used to produce renewable, net-zero carbon fuels. These fuels can be used as substitutes for existing fossil-based hydrocarbon fuels. Renewable fuels can be generated by producing hydrogen through splitting water using renewable, carbon-free energy sources. For example, water electrolysis can be used to produce hydrogen by splitting water using renewable energy sources. This hydrogen can be combined with a non-combustible gas, such as nitrogen (N₂) or carbon dioxide (CO₂) to produce renewable fuels, such as ammonia, methanol, other hydrocarbon fuels (e.g., synthetic oil), and the like.

### SUMMARY

In at least one example of the present disclosure, a reactor system includes a variable feed of non-combustible gas, an intermittent hydrogen supply coupled to a hydrogen gas buffer, the hydrogen gas buffer providing a variable feed of hydrogen gas, a reactor coupled to the variable feed of non-combustible gas and the variable feed of hydrogen gas, the reactor configured to convert the non-combustible gas and the hydrogen gas into a renewable fuel product, a heat exchanger coupled to an outlet of the reactor, a phase separator coupled to an outlet of the heat exchanger, the phase separator being configured to separate a gas stream including un-reacted hydrogen and un-reacted non-combustible gas from a liquid stream including the renewable fuel product, and a burner configured to combust the un-reacted hydrogen contained in the gas stream. The reactor can include an internal heat exchanger configured to provide cooling to the reactor in a normal operating mode and to provide heating to the reactor in an idle mode.

In some examples, the reactor system can further include a last reactor coupled to the gas stream exiting the phase separator, a last heat exchanger coupled to an outlet of the last reactor, and a last phase separator coupled to an outlet of the last heat exchanger. The last phase separator can be configured to separate a last gas stream including un-reacted hydrogen and un-reacted non-combustible gas from a last liquid stream. The burner can be further configured to combust the un-reacted hydrogen contained in the last gas stream.

In some examples, the reactor system can further include a buffer tank coupled to collect the liquid stream and the last liquid stream, and a distillation column coupled to the buffer tank. The distillation column can be configured to separate the renewable fuel product from by-products. The internal heat exchanger and a last internal heat exchanger of the last reactor can be coupled to a reboiler of the distillation column. A heat transfer fluid can flow through the internal heat exchanger, the last internal heat exchanger, and the reboiler.

In some examples, the burner can be configured to supply heat to the reboiler of the distillation column and to the heat transfer fluid entering the internal heat exchanger of the reactor and entering the last internal heat exchanger of the last reactor. In some examples, the heat transfer fluid can include pressurized boiling water. In some examples, the distillation column can be further configured to separate a non-combustible gas stream dissolved in the liquid stream from the renewable fuel product and the by-products. The reactor system can further include a compressor configured to recycle the non-combustible gas stream to the variable feed of non-combustible gas.

In some examples, the variable feed of non-combustible gas and the hydrogen gas buffer can contain gases at pressures above an operating pressure of the reactor. In some examples, the variable feed of non-combustible gas can include nitrogen and the renewable fuel product can include ammonia. In some examples, the variable feed of non-combustible gas can include carbon dioxide and the renewable fuel product can include methanol.

In at least one example of the present disclosure, a method includes monitoring a condition of a hydrogen supply, in response to the condition of the hydrogen supply being greater than a threshold value, operating a reactor system in a normal operating mode, and in response to the condition of the hydrogen supply being less than the threshold value, operating the reactor system in an idle mode. In the normal operating mode, a hydrogen feed rate and a non-combustible gas feed rate to a reactor are varied based on the condition of the hydrogen supply. In the idle mode, the hydrogen feed rate to the reactor is reduced to a minimum value, and the non-combustible gas feed rate to the reactor is stopped.

In some examples, the condition of hydrogen supply can include at least one of power generated by a renewable energy source, a forecast for power generated by the renewable energy source, or a quantity of hydrogen in a hydrogen gas storage of the reactor system.

In some examples, operating the reactor system in the idle mode can further include combusting hydrogen from the hydrogen feed after passing the hydrogen through the reactor. In some examples, the minimum value of the hydrogen feed rate in the idle mode can be controlled to provide sufficient heat from combusting the hydrogen to maintain temperatures of the reactor and a distillation column at or near normal operating temperatures.

In at least one example of the present disclosure, a reactor system includes a controllable non-combustible gas feed, an intermittent hydrogen supply coupled to a hydrogen gas buffer, the hydrogen gas buffer providing a controllable hydrogen gas feed, a heat exchange reactor including a plurality of catalytic stages, a last phase separator coupled to an outlet of a last catalytic stage, the last phase separator being configured to separate a last gas stream including un-reacted hydrogen and un-reacted non-combustible gas from a last liquid stream including the renewable fuel product, and a burner configured to combust the un-reacted hydrogen contained in the last gas stream. The heat exchange reactor includes an inlet and an outlet for a heat transfer fluid, the heat transfer fluid configured to provide cooling to the catalytic stages in a normal operating mode and to provide heating to the catalytic stages in an idle mode. A first catalytic stage of the catalytic stages is coupled to the non-combustible gas feed and the hydrogen gas feed, thermally coupled to the heat transfer fluid, and configured to convert non-combustible gas of the non-combustible gas feed and hydrogen gas of the hydrogen gas feed into a renewable fuel product. A last catalytic stage of the catalytic stages is coupled to a gas stream exiting a phase separator coupled to one of the catalytic stages, thermally coupled to the heat transfer fluid, and configured to convert the gas stream into the renewable fuel product.

In some examples, the reactor system can further include a first heat exchanger coupled to an outlet of the first catalytic stage, a first phase separator coupled to an outlet of the first heat exchanger and configured to separate a first gas stream from a first liquid stream, a buffer tank coupled to the first liquid stream and the last liquid stream, and a distillation column coupled to the buffer tank. The distillation column can be configured to separate the renewable fuel product from a liquid by-product. In some examples, the burner is configured to supply heat to the heat transfer fluid entering the heat exchange reactor and to a reboiler of the distillation column, and the outlet for the heat transfer fluid of the heat exchange reactor is coupled to an inlet of a reboiler of the distillation column. In some examples, the heat transfer fluid can include pressurized boiling water.

In some examples, the distillation column can be further configured to separate un-reacted non-combustible gas dissolved in the first liquid stream and the last liquid stream from the renewable fuel product and the liquid by-product. The reactor system can further include a compressor configured to recycle the un-reacted non-combustible gas from the distillation column to the non-combustible gas feed.

In some examples, the non-combustible gas feed and the hydrogen gas buffer can contain gases at pressures above an operating pressure of the catalytic stages of the heat exchange reactor. In some examples, the non-combustible gas feed can include carbon dioxide and the renewable fuel product can include methanol.

Features from any of the above-mentioned examples may be used in combination with one another in accordance with the general principles described herein. These and other examples, features, and advantages will be more fully understood upon reading the following detailed description in conjunction with the accompanying drawings and claims.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 shows a schematic view of a system for producing renewable fuel.

FIG. 2 shows a schematic view of a system for producing renewable fuel.

FIG. 3 shows a schematic view of a system for producing renewable fuel.

FIG. 4 shows a schematic view of a system for producing renewable fuel.

FIG. 5 shows a flow chart of a method for producing renewable fuel.

FIG. 6 shows a block diagram of a computing system that can be used in a system for producing renewable fuel.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

Throughout the following disclosure and the accompanying drawings, specific pieces of equipment are described and illustrated. Respective pieces of equipment can be described as being connected to or coupled to other pieces of equipment. This includes both direct connections and indirect connections. Specifically, two pieces of equipment can be described as being connected or coupled to one another, even when other pieces of equipment are disposed between those pieces of equipment. Terms such as “a” or “an” include at least one, and may refer to multiple components. Components that are configured to perform an operation can perform at least that operation, in addition to other operations. For example, a burner that is configured to combust hydrogen can combust other fuels in addition to hydrogen, but is at least configured to combust hydrogen.

The following disclosure relates to systems and methods for producing renewable fuels. More particularly, the present disclosure relates to systems and methods for producing renewable fuels from reactions between hydrogen and non-combustible gases (e.g., nitrogen, carbon dioxide, or the like). The renewable fuels can include ammonia, methanol, other hydrocarbon fuels, synthetic oil, or the like. The renewable fuel generation system can be directly integrated with a renewable energy source, such as a solar power plant, a wind turbine plant, a geothermal power plant, a hydropower plant, or another renewable energy source. Power from the renewable energy source can be used to produce hydrogen (e.g., green hydrogen) through a process such as electrolysis. The amount of power generated from the renewable energy source can be intermittent or fluctuating, such that the amount of hydrogen supplied to the renewable fuel generation system is intermittent or fluctuating.

As such, the renewable fuel generation system can be configured to operate in a normal operating state when the hydrogen supply from the renewable energy source is above a threshold flowrate and in an idle state when the hydrogen supply from the renewable energy source is below the threshold flowrate. The idle state can include ceasing flow of the non-combustible gases through the renewable fuel generation system, while flowing a minimal amount of hydrogen through the renewable fuel generation system. The hydrogen can be used to maintain components of the renewable fuel generation system at pressure (e.g., at or near a normal operating pressure), which can be used to prevent contamination of catalysts in reactors of the renewable fuel generation system. Specifically, exposure of the catalysts to air can contaminate the catalysts and necessitate replacement of the catalysts. Moreover, the hydrogen can be burned by burners in the renewable fuel generation system, and can supply heat to components of the renewable fuel generation system to maintain the components at or near normal operating temperatures. This minimizes time and costs associated with start-up and shut-down processes of the renewable fuel generation system. This further increases generation of renewable fuels from the renewable fuel generation system.

In order for renewable fuels to be competitive with non-renewable fuels, renewable fuels have to be cost-competitive with analogous fuels produced from non-renewable sources, such as coal, natural gas, and oil. The cost of renewable electricity constitutes a large share of the cost of renewable fuel production. Thus, in order to reduce the cost of renewable fuel production, costs of renewable electricity can be minimized. The costs of renewable fuel production can be reduced by producing hydrogen for a renewable fuel generation system through water electrolysis units that use electricity provided directly from renewable energy sources. The renewable fuel generation system can further be powered by electricity provided directly from the renewable energy sources. These renewable energy sources can include a solar power plant, a wind turbine plant, a geothermal power plant, a hydropower plant, or another renewable energy sources. Electricity supply from these renewable energy sources can be intermittent by nature and can be interrupted or reduced for extended periods of time. Existing fuel production technologies (e.g., hydrocarbon synthesis technologies and the like) are designed for continuous operation, and typically utilize natural gas feedstock (produced from fossil gas) and electricity from an electrical grid. The present disclosure describes systems and methods that allow for renewable fuel production utilizing renewable energy sources that can be intermittent or fluctuating.

In a renewable fuel generation system, renewable fuels can be generated from a hydrogen gas (H₂) feed and a non-combustible gas feed. The hydrogen gas feed can be provided from a water electrolysis unit or the like, and can be produced using renewable electricity, as described above. The non-combustible gas feed can include nitrogen (N₂), carbon dioxide (CO₂), or the like. Carbon dioxide can be captured from an industrial source, or can be captured directly from the atmosphere. Similarly, nitrogen can be captured directly from the atmosphere. The renewable fuels can include ammonia (NH₃), methanol (CH₃OH), higher-molecular weight hydrocarbon liquid fuels, synthetic oil, and the like.

Several chemical reactions can be involved in the synthesis of renewable fuels. For example, ammonia synthesis from hydrogen (H₂) and nitrogen (N₂) through a Haber-Bosch (HB) process can proceed according to equation 1, below. Methanol, a liquid hydrocarbon fuel, can by synthesized from hydrogen and carbon dioxide (CO₂) through methanol synthesis, which can proceed according to equation 2. Other liquid hydrocarbon fuels can be synthesized from hydrogen and carbon dioxide through a combination of a reverse water gas shift process, which can proceed according to equation 3, and Fischer-Tropsch (FT) synthesis, which can proceed according to equation 4.

N₂+3H₂→2NH₃ (1)

CO₂+3H₂→CH₃OH+H₂O (2)

CO₂+H₂→CO+H₂O (3)

CO+2H₂→—(CH₂)—+H₂O (4)

Additional details of FT synthesis are provided in U.S. Pat. No. 4,282,187, the entire disclosure of which is incorporated herein, by reference.

In a renewable fuel generation system, the reactions of equations 1-4 can be carried out in a synthesis reactor. Due to kinetic or equilibrium limitations, the reactions of equations 1-4 generally do not proceed to completion within the synthesis reactor. Thus, a significant portion of unconverted hydrogen and non-combustible gas can be present in a product mixture in an exit stream of the synthesis reactor. In existing synthesis systems, this product stream is generally cooled to condense liquids containing the renewable fuel product. This stream can be passed through a separator, which separates the liquids from the gas mixture containing unconverted hydrogen and non-combustible gas.

To maximize the output of the renewable fuel product in the existing synthesis systems, the gas mixture recovered from the separator can be recycled to the synthesis reactor feed using a recycle compressor. However, gas compressors operate in a narrow range of flow, which severely limits the range of the synthesis system operation and does not allow for adjustment of the renewable fuel production rate in response to variations in the availability of renewable electricity. Processes for starting and stopping the various components in the synthesis reactor systems can require significant auxiliary operations, such as providing inert gas for purging, providing an auxiliary steam supply for pre-heating the synthesis reactor, and other requirements. This does not allow for frequent start-ups and stops of the synthesis reactor systems in response to fluctuations or intermittence of the feedstock or renewable electricity provided to the synthesis system. As an example, U.S. Pat. No. 11,685,865 teaches a system for production of renewable hydrocarbon fuels that operates in an idle operating mode when renewable power is not available. However, this system includes a recycle compressor that would require excessive consumption of energy and prevent the system from operating in the idle operating mode. Thus, it is desirable to provide a renewable fuel generation system that includes an idle operating mode, can vary operation in response to intermittence or fluctuation in power provided by renewable energy sources, and does not include complicated, energy-intensive, time consuming start-up and shut-down processes. This can increase renewable fuel production.

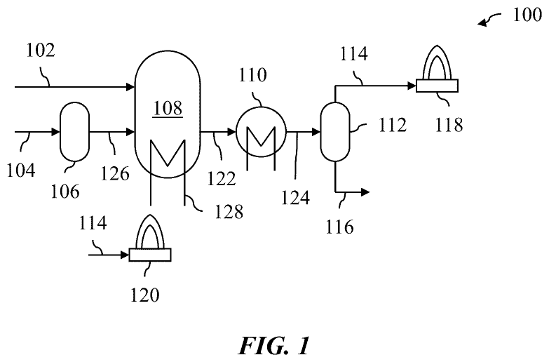

These and other embodiments are discussed below with reference to FIGS. 1 through 6. However, those skilled in the art will readily appreciate that the detailed description given herein with respect to these Figures is for explanatory purposes only and should not be construed as limiting. Furthermore, as used herein, a system, a method, an article, a component, a feature, or a sub-feature including at least one of a first option, a second option, or a third option should be understood as referring to a system, a method, an article, a component, a feature, or a sub-feature that can include one of each listed option (e.g., only one of the first option, only one of the second option, or only one of the third option), multiple of a single listed option (e.g., two or more of the first option), two options simultaneously (e.g., one of the first option and one of the second option), or combination thereof (e.g., two of the first option and one of the second option).

FIG. 1 illustrates a reactor system 100 that can be used in a dynamic operation for renewable fuel synthesis. The reactor system 100 can be used to produce renewable fuels, and can operate in conjunction with renewable energy sources. The renewable energy sources can generate power from sunlight, wind, tides, water, heat, biomass, or the like. The reactor system 100 can convert a non-combustible gas feed 102 and a hydrogen gas supply 104 into a renewable fuel product 116. The renewable fuel product 116 can be a liquid fuel product. The reactor system 100 can include a reactor 108 (also referred to as a synthesis reactor), a heat exchanger 110, and a separator 112.

The reactor 108 can convert the non-combustible gas feed 102 and a hydrogen gas feed 126 into a product stream 122. The reactor 108 can be a catalytic reactor. Various types of reactors can be used for the reactor 108. The product stream 122 can include the renewable fuel product and un-reacted hydrogen and non-combustible gas from the non-combustible gas feed 102 and the hydrogen gas feed 126. The product stream 122 can be fed to the heat exchanger 110, which can cool the product stream 122 and produce a cooled product stream 124. The cooled product stream 124 can be fed to the separator 112. The separator 112 can be a phase separator unit, which can separate the cooled product stream 124 into a gaseous mixture 114 and the renewable fuel product 116 (e.g., a liquid fuel product). The gaseous mixture 114 can include un-reacted hydrogen and non-combustible gas from the non-combustible gas feed 102 and the hydrogen gas supply 104. The renewable fuel product 116 can include any of the renewable fuel products discussed above, such as ammonia, methanol, other liquid hydrocarbon fuels, or the like. The renewable fuel product 116 can include a liquid product (e.g., liquid ammonia, liquid methanol, other liquid hydrocarbon fuels, or the like).

During normal operation (referred to as a normal operating state or mode), the gaseous mixture 114 can be fed to a burner 118. The burner 118 can combust the gaseous mixture 114 exiting the separator 112, and can produce heat that can be used by the reactor system 100. For example, the heat can be used in an air separation unit to produce nitrogen, which can be included in the non-combustible gas feed 102. The heat can be used in a carbon dioxide capture system, a renewable fuel product distillation system, or the like.

The non-combustible gas feed 102 can include any gas that does not react with oxygen in the air to produce heat, but can be combined with hydrogen to produce renewable fuel. The renewable fuel can be reacted (e.g., burned) with oxygen in the air to produce heat. Examples of gases that can be included in the non-combustible gas feed 102 may include nitrogen (N₂), which can be used to produce ammonia, or carbon dioxide (CO₂), which can be used to produce hydrocarbon fuels, such as methanol, other hydrocarbon fuels, synthetic oil, and the like. The non-combustible gas feed 102 can be variable (e.g., controllable), and can be varied based on the hydrogen gas supply 104 and the hydrogen gas feed 126 in order to provide a desired stoichiometric ratio of non-combustible gas and hydrogen to the reactor 108. For example, for the reactions represented by equations 1-4, a molar ratio of the hydrogen gas feed 126 to the non-combustible gas feed 102 can be in a range from about 2.5 to about 3.5, or about 3. This can optimize production of the renewable fuel product 116 by the reactor system 100 by maximizing conversion of the non-combustible gas and hydrogen to the renewable fuel product 116.

In examples in which the non-combustible gas feed 102 includes carbon dioxide, the carbon dioxide can be captured from a process stream, from air, or the like. For example, carbon dioxide can be captured from a combustion source, such as a power plant. Amine scrubbing can be used to capture carbon dioxide emitted by industrial processes, power plants, and the like. Carbon dioxide and nitrogen can be captured directly from air. The technology used to capture carbon dioxide used in the non-combustible gas feed 102 can be selected based on the concentration of carbon dioxide in the capture stream and used in the non-combustible gas feed 102. Any suitable carbon dioxide capture technologies can be used.

The hydrogen gas supply 104 can be provided by a hydrogen generator, which can be powered by electricity from a renewable energy source. The hydrogen generator can be a water electrolysis system, which uses electricity from the renewable energy source and a water feed to split the water into hydrogen and oxygen. The renewable energy source can include a wind turbine, a photovoltaic solar panel, a geothermal generator, a hydroelectric generator, or any other renewable energy sources. The renewable energy source can produce a fluctuating, variable, or intermittent supply of electricity, which can cause the hydrogen gas supply 104 produced by the hydrogen generator to vary. In order to accommodate this variation in the hydrogen gas supply 104, the reactor system 100 can include a hydrogen buffer tank 106 and the reactor system 100 can operate in an idle state or mode.

The hydrogen buffer tank 106 can be used to supply a variable or controlled hydrogen gas feed 126 to the reactor 108. In some examples, the reactor system 100 can include a hydrogen storage tank, and the hydrogen storage tank can provide hydrogen that can be included in the hydrogen supply 104. The hydrogen storage tank can be considered to be part of the hydrogen gas supply 104. The hydrogen buffer tank 106 and the hydrogen storage tank can be collectively referred to as upstream hydrogen storage or upstream system storage. The hydrogen storage tank can be maintained at an elevated pressure, such as above the hydrogen buffer tank pressure. In some examples, the non-combustible gas feed 102 can include a non-combustible buffer tank and/or a non-combustible storage tank similar to the hydrogen buffer tank and the hydrogen storage tank, respectively. The hydrogen buffer tank 106 and the non-combustible gas buffer tank can be maintained at pressures above an operating pressure of the reactor 108 in order to provide a pressure differential between the hydrogen buffer tank 106 and the non-combustible gas buffer tank and the reactor 108 and to pressurize the reactor 108. By maintaining the hydrogen buffer tank 106 at the pressure above the operating pressure of the reactor 108, the hydrogen buffer tank 106 is able to provide the hydrogen gas feed 126 when the reactor system 100 is in the idle mode.

As illustrated in FIG. 1, the reactor system 100 can include the hydrogen buffer tank 106 upstream from the reactor 108. The hydrogen buffer tank 106 can be configured to store hydrogen at pressure above an operating pressure of the reactor 108. The hydrogen gas supply 104 provided by the upstream water splitting system can vary depending on the amount of the renewable power available at any particular moment. For example, the hydrogen gas supply 104 can increase at times of high renewable power availability (e.g., bright sun, strong wind, fast flowing water, etc.) and can decrease or stop at times of low or no renewable power availability. The hydrogen buffer tank 106 provides buffering for the variability in the hydrogen gas supply 104. The upstream system storage is charged with hydrogen when a relatively high hydrogen gas supply 104 is available and is discharged when a relatively low hydrogen gas supply 104 or no hydrogen gas supply 104 is available. In examples that include a hydrogen storage tank, the hydrogen buffer tank 106 can charge or discharge the hydrogen storage tank depending on the hydrogen gas supply 104.

A hydrogen gas feed 126 (also referred to as a buffered hydrogen gas feed) can be provided from the hydrogen buffer tank 106 to the reactor 108. Flowrates of the hydrogen gas feed 126 and the non-combustible gas feed 102 can be adjusted (e.g., controlled or varied) in response to varying amounts of power being available from the renewable energy sources for the production of hydrogen. More specifically, the flowrate of the hydrogen gas feed 126 can be adjusted based on the availability of hydrogen from the hydrogen gas supply 104, and the non-combustible gas feed 102 can be adjusted proportionally to the hydrogen gas feed 126. The flowrate of the hydrogen gas feed 126 to the reactor 108 can be controlled based on the forecasts for renewable power availability and the amount of hydrogen gas stored in the hydrogen storage tank. This ensures a continuous flow of hydrogen gas to the reactor 108, even over periods of low power production from the renewable energy sources. The flowrate of the non-combustible gas feed 102 supplied to the reactor 108 can be controlled to maintain a specified stoichiometry for the synthesis reaction producing the renewable fuel product 116 (e.g., for the reactions of equations 1-4, a molar ratio of the hydrogen gas feed 126 to the non-combustible gas feed 102 can be in a range from about 2.5 to about 3.5, or about 3).

The reactor system 100 can operate in an idle state for periods of time when power is low or not available from the renewable energy sources. For example, when power from the renewable energy sources decreases below a threshold value (e.g., when the hydrogen gas supply 104 or a forecast for the hydrogen gas supply 104 decreases below a threshold flowrate) and the amount of hydrogen in the upstream system storage decreases below a threshold value, the flowrate of the non-combustible gas feed 102 to the reactor 108 can be stopped. The flowrate of the hydrogen gas feed 126 to the reactor 108 can be minimized. When the reactor system 100 operates in the idle state, the gaseous mixture 114 can include hydrogen from the hydrogen gas feed 126 that is passed through the reactor 108, the heat exchanger 110 and the separator 112. The gaseous mixture 114 can be directed to a burner 120. The hydrogen gas can be combusted by the burner 120 in order to produce a sufficient amount of heat to maintain the reactor system 100 in the idle state for a period of time until renewable power becomes available again. In some examples, the burner 120 can be omitted, and the burner 118 can be used to provide heat for the reactor system 100 when the reactor system 100 is in the normal operating state or the idle state. The flow of hydrogen from the hydrogen gas feed 126 to the burner 120 can be controlled to maintain the reactor 108 and any other components of the reactor system 100 at or near normal operating temperatures. Near normal operating temperatures can include temperatures within about 50° C. of the normal operating temperatures of the reactor 108. This reduces start-up times for resuming production of the renewable fuel product 116 by the reactor system 100 when power from the renewable energy sources becomes available again and the flowrate of the hydrogen gas supply 104 increases to a threshold value. In the idle state, hydrogen from the hydrogen gas feed 126 is directed to the reactor 108 and can be used to maintain an elevated pressure in the reactor 108. For example, the pressure of the reactor 108 can be maintained at or near a normal operating pressure. This ensures that any catalysts include in the reactor 108 are not exposed to outside air and prevents contamination of the catalysts, which reduces downtime and costs related to replacing the catalyst.

The reactions of equations 1-4, which are carried out in the reactor 108, can be performed at an elevated temperature and can be exothermic. As such, the reactor 108 can be pre-heated to initiate the reactions. The reactor 108 can be cooled during normal operation of the reactor 108 to remove heat generated by the reactions and avoid over-heating of the reactor 108. The reactor 108 can include a heat exchanger through which a heat transfer medium 128 travels. The heat transfer medium 128 can be alternatively referred to as a heat transfer fluid or the like. During normal operation of the reactor system 100, the heat transfer medium 128 can remove heat generated by the reactions in the reactor 108. When the reactor system 100 is in the idle state, the burner 120 and/or the burner 118 can heat the heat transfer medium 128 in order to maintain the reactor 108 at or near a normal operating temperature. The heat transfer medium 128 entering the heat exchanger of the reactor 108 can include pressurized water that is at or near boiling in both the idle state and normal operation. During normal operation, the heat transfer medium 128 boils as it passes through the heat exchanger of the reactor 108, removing heat from the reactor 108. During the idle state, the heat transfer medium 128 maintains the reactor 108 at or near the normal operating temperature.

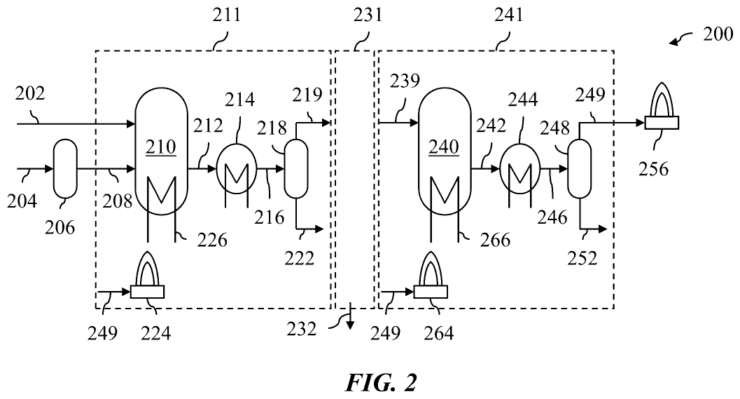

FIG. 2 illustrates a reactor system 200 that can be used in a dynamic operation for renewable fuel synthesis. The reactor system 200 can be used to produce renewable fuels, and can operate in conjunction with renewable energy sources. The reactor system 200 can be the same as or similar to the reactor system 100, except that the reactor system 200 includes a series of reactor sub-systems 211, 231, 241. More specifically, the reactor system 200 can include at least some components that are the same as or similar to components of the reactor system 100. Utilizing a series of reactor sub-systems 211, 231, 241 can be beneficial in cases in which the reactions that are carried out in reactors 210, 240 of the reactor sub-systems 211, 231, 241 to produce renewable fuel products are reversible. For example, the reactions of equations 1 and 2 are reversible reactions, and can be carried out in the reactor system 200. The extent of conversion of hydrogen and non-combustible gas in each of the reactor sub-systems 211, 231, 241 of the reactor system 200 can be limited by process equilibrium, and multiple reactor sub-systems 211, 231, 241 can be included to increase the extent of conversion of the overall reactor system 200.

The reactor system 200 can convert a non-combustible gas feed 202 and a hydrogen gas supply 204 into renewable fuel products 222, 232, 252. The reactor system 200 can include reactor sub-systems 211, 231, 241, which can each include reactors 210, 240, heat exchangers 214, 244, and separators 218, 248. The reactors 210, 240 can be catalytic reactors. The reactor system 200 can include burners 224, 254, 256, which can burn hydrogen gas passing through the reactor system 200, and can be used to supply heat to various components of the reactor system 200. The reactor sub-system 231 can be the same as or similar to the reactor sub-system 211, including the same or similar components to the reactor sub-system 211. The reactor sub-system 231 can include any number of repeating reactor sub-systems, depending on the processes performed in the reactor system 200, operating conditions for the processes performed in the reactor system 200, and the like. For example, depending on the specific reaction that takes place in the reactor system 200, the condition of catalysts in the reactors of the reactor system 200, operating temperatures and pressures in the reactor system 200, and the like, a different number of reactor sub-systems 231 can be included in the reactor system 200. In some examples, the reactor sub-system 231 can be optionally omitted. The reactor sub-system 241 can be a last reactor sub-system (e.g., a most downstream reactor sub-system) in the reactor system 200. The reactor 240 can be a last reactor, the heat exchanger 244 can be a last heat exchanger, and the separator 248 can be a last separator.

The degree of conversion in each reactor 210, 240 in the series of reactor sub-systems 211, 231, 241 depends on the temperature, pressure, catalyst activity (e.g., catalyst age, catalyst oxidation, and the like), and other operating conditions of the respective reactor 210, 240. The number of the reactor sub-systems included in the reactor system 200 can be selected depending on the specifics of the particular process performed in the reactor system 200. Generally, the number of reactors 210, 240 and the number of reactor sub-systems 211, 231, 241 included in the reactor system 200 can be selected to achieve a balance between an amount of hydrogen left in a gaseous mixture 249 exiting the separator 248 of the last reactor sub-system 241 and heat duties of the processes carried out in the reactor system 200 that can be supplied by the burners 224, 254, 256.

The reactor system 200 can include the non-combustible gas feed 202 and the hydrogen gas supply 204. The hydrogen gas supply 204 can be fed to a hydrogen buffer tank 206, which can buffer a variable input of the hydrogen gas supply 204 and deliver a hydrogen gas feed 208 (also referred to as a buffered hydrogen gas feed) to the reactor 210.

The reactor 210 can convert the non-combustible gas feed 202 and the hydrogen gas feed 208 into a product stream 212. The product stream 212 can include the renewable fuel product and un-reacted hydrogen and non-combustible gas from the non-combustible gas feed 202 and the hydrogen gas feed 208. The product stream 212 can be fed to the heat exchanger 214, which can cool the product stream 212 and produce a cooled product stream 216. The cooled product stream 216 can be fed to the separator 218. The separator 218 can be a phase separator unit, which can separate the cooled product stream 216 into a gaseous mixture 219 and the renewable fuel product 222 (e.g., a liquid fuel product). The gaseous mixture 219 can include un-reacted hydrogen and non-combustible gas from the non-combustible gas feed 202 and the hydrogen gas feed 208. The renewable fuel product 222 can include any of the renewable fuel products discussed above, such as ammonia, methanol, other liquid hydrocarbon fuels, and the like. The renewable fuel product 222 can include a liquid product (e.g., liquid ammonia, liquid methanol, other liquid hydrocarbon fuels, or the like).

The reactor sub-system 231 can include the same or similar components to the reactor sub-system 211, and can perform the same or similar processes to produce the same or similar exit streams as the reactor sub-system 211. The reactor sub-system 231 can include the gaseous mixture 219 as a reactant (including un-reacted hydrogen and non-combustible gas), and can produce a renewable fuel product 232 (e.g., a liquid fuel product) and a gaseous mixture 239 (including un-reacted hydrogen and non-combustible gas) as products.

The reactor 240 can convert the gaseous mixture 239 into a product stream 242. The product stream 242 can include the renewable fuel product and un-reacted hydrogen and non-combustible gas from the non-combustible gas feed 202 and the hydrogen gas feed 208 (e.g., that remains un-reacted after passing through the reactor sub-systems 211, 231). The product stream 242 can be fed to the heat exchanger 244, which can cool the product stream 242 and produce a cooled product stream 246. The cooled product stream 246 can be fed to the separator 248. The separator 248 can be a phase separator unit, which can separate the cooled product stream 246 into a gaseous mixture 249 and the renewable fuel product 252 (e.g., a liquid fuel product). The gaseous mixture 249 can include un-reacted hydrogen and non-combustible gas from the non-combustible gas feed 202 and the hydrogen gas feed 208. The renewable fuel product 252 can include any of the renewable fuel products discussed above, such as ammonia, methanol, other liquid hydrocarbon fuels, and the like. The renewable fuel product 252 can include a liquid product (e.g., liquid ammonia, liquid methanol, other liquid hydrocarbon fuels, or the like).

The renewable fuel products 222, 232, 252 can be separated from the gaseous mixtures 219, 239, 249 in each of the reactor sub-systems 211, 231, 241. This removes equilibrium limitations for un-reacted hydrogen and non-combustible gas in downstream reactors of the reactor system 200 (e.g., the reactor of the sub-system 231 and the reactor 240) so that further conversion of the un-reacted reactants to product can occur in the downstream reactors.

Similar to the reactor system 100, during normal operation, the gaseous mixture 249 can be fed to the burner 256. The burner 256 can combust any un-reacted hydrogen in the gaseous mixture 249 and can produce heat that can be used by the reactor system 200. For example, the heat can be used in an air separation unit to produce nitrogen, which can be included in the non-combustible gas feed 202. The heat can be used in a carbon dioxide capture system, a renewable fuel product distillation system, or the like.

The reactor system 200 can operate in an idle state for periods of time when power is low or not available from the renewable energy sources. For example, when power from the renewable energy sources decreases below a threshold value (e.g., when the hydrogen gas supply 204 or a forecast for the hydrogen gas supply 204 decreases below a threshold flowrate) and the amount of hydrogen in the upstream system storage decreases below a threshold value, the flowrate of the non-combustible gas feed 202 to the reactor 210 can be stopped. The flowrate of the hydrogen gas feed 208 to the reactor 210 can be minimized. When the reactor system 200 operates in the idle state, the gaseous mixture 249 can include hydrogen from the hydrogen gas feed 208 that is passed through the reactors 210, 240, the heat exchangers 214, 244, the separators 218, 248, and any components of the reactor sub-system 231. The gaseous mixture 249 can be directed to the burners 224, 264 and any burners of the reactor sub-systems 231. The hydrogen gas can be combusted by the burners 224, 264, and any burners of the reactor sub-systems 231 in order to produce a sufficient amount of heat to maintain the reactor system 200 in the idle state for a period of time until renewable power becomes available again. In some examples, the burners 224, 264, and any burners of the reactor sub-systems 231 can be omitted, and the burner 256 can be used to provide heat for the reactor system 200 when the reactor system 200 is in the normal operating state or the idle state. The flow of hydrogen from the hydrogen gas feed 208 to the burners 224, 254, and any burners of the reactor sub-systems 231 can be controlled to maintain the reactors 210, 240, and any reactors of the reactor sub-systems 231 and any other components of the reactor system 200 at or near (e.g., within about 50° C. of) normal operating temperatures. This reduces start-up times for resuming production of the renewable fuel products 222, 232, 252 by the reactor system 200 when power from the renewable energy sources becomes available again and the flowrate of the hydrogen gas supply 204 increases to a threshold value. In the idle state, hydrogen from the hydrogen gas feed 208 is directed to the reactors 210, 240, and any reactors of the reactor sub-systems 231 and can be used to maintain an elevated pressure in the reactors 210, 240, and any reactors of the reactor sub-systems 231. For example, the pressure of the reactors 210, 240 and any reactors of the reactor sub-systems 231 can be maintained at or near normal operating pressures. This ensures that any catalysts include in the reactors 210, 240, and any reactors of the reactor sub-systems 231 are not exposed to outside air and prevents contamination of the catalysts, which reduces downtime and costs related to replacing the catalyst.

The reactions of equations 1-4, which are carried out in the reactors 210, 240, and any reactors of the reactor sub-systems 231, can be performed at an elevated temperature and can be exothermic. As such, the reactors 210, 240, and any reactors of the reactor sub-systems 231 can be pre-heated to initiate the reactions. The reactors 210, 240, and any reactors of the reactor sub-systems 231 can be cooled during normal operation of the reactors 210, 240, and any reactors of the reactor sub-systems 231 to remove heat generated by the reactions and avoid over-heating of the reactors 210, 240, and any reactors of the reactor sub-systems 231. The reactors 210, 240, and any reactors of the reactor sub-systems 231 can include heat exchangers through which a heat transfer mediums 226, 266 travel.

During normal operation of the reactor system 200, the heat transfer mediums 226, 266 can remove heat generated by the reactions in the reactors 210, 240, and any reactors of the reactor sub-systems 231. When the reactor system 200 is in the idle state, any combination of the burners 224, 254, 256, and any burners of the reactor sub-systems 231 can heat the heat transfer mediums 226, 266 in order to maintain the reactors 210, 240, and any reactors of the reactor sub-systems 231 at or near normal operating temperatures. More specifically, the heat transfer mediums 226, 266 entering the heat exchangers of the reactors 210, 240 can include pressurized water that is at or near boiling in both the idle state and normal operation. During normal operation, the heat transfer mediums 226, 266 boil as they passes through the heat exchangers of the reactors 210, 240, removing heat from the reactors 210, 240. During the idle state, the heat transfer mediums 226, 266 maintain the reactors 210, 240 at or near the normal operating temperatures. Any reactors of the reactor sub-systems 231 function the same way as the reactors 210, 240.

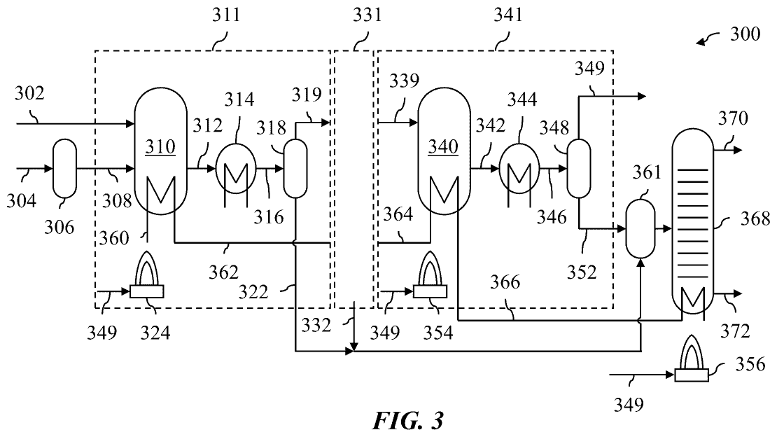

FIG. 3 illustrates a reactor system 300 that can be used in a dynamic operation for renewable fuel synthesis. The reactor system 300 can be used to produce renewable fuels, and can operate in conjunction with renewable energy sources. The reactor system 300 can be the same as or similar to the reactor system 200, except that the reactor system 300 includes a buffer tank 361 and a distillation column 368. The buffer tank 361 can be coupled to collect the liquid streams 322, 332, 352. The distillation column 368 can be used to separate liquid products of the reactor system 300 from one another. More specifically, the reactor system 300 can include at least some components that are the same as or similar to components of the reactor system 200. Including the distillation column 368 can be beneficial in cases in which the liquid products of the reactor system 300 include a renewable fuel product mixed with liquid by-products produced by the reactors of the reactor system 300. For example, the reaction of equation 2 can produce a product that includes a renewable fuel product (e.g., methanol) mixed with a liquid by-product (e.g., water). The distillation column 368 can be used to separate the renewable fuel product from the liquid by-product in order to produce a renewable fuel product 370 that is free from the liquid by-product.

The reactor system 300 can convert a non-combustible gas feed 302 and a hydrogen gas supply 304 into a renewable fuel product 370. The reactor system 300 can include reactor sub-systems 311, 331, 341, which can each include a reactor 310, 340, a heat exchanger 314, 344, and a separator 318, 348. The reactors 310, 340 can be catalytic reactors. The reactor system 300 can include burners 324, 354, 356, which can burn hydrogen gas passing through the reactor system 300, and can be used to supply heat to various components of the reactor system 300. The reactor sub-system 331 can be the same as or similar to the reactor sub-system 311, including the same or similar components to the reactor sub-system 311. The reactor sub-system 331 can include any number of repeating reactor sub-systems. In some examples, the reactor sub-system 331 can be optionally omitted. The reactor sub-system 341 can be a last reactor sub-system (e.g., a most downstream reactor sub-system) in the reactor system 300. The reactor 340 can be a last reactor, the heat exchanger 344 can be a last heat exchanger, and the separator 348 can be a last separator.

The degree of conversion in each reactor 310, 340 in the series of reactor sub-systems 311, 331, 341 depends on the temperature, pressure, catalyst activity, and other operating conditions of the respective reactor 310, 340. The number of the reactor sub-systems included in the reactor system 300 can be selected depending on the specifics of the particular process performed in the reactor system 300. Generally, the number of reactors 310, 340 and the number of reactor sub-systems 311, 331, 341 included in the reactor system 300 can be selected to achieve a balance between an amount of hydrogen left in a gaseous mixture 349 exiting the separator 348 of the last reactor sub-system 341 and heat duties of the processes carried out in the reactor system 300 that can be supplied by the burners 324, 354, 356.

The reactor system 300 can include the non-combustible gas feed 302 and the hydrogen gas supply 304. The hydrogen gas supply 304 can be fed to a hydrogen buffer tank 306, which can buffer a variable input of the hydrogen gas supply 304 and deliver a hydrogen gas feed 308 (also referred to as a buffered hydrogen gas feed) to the reactor 310.

The reactor 310 can convert the non-combustible gas feed 302 and the hydrogen gas feed 308 into a product stream 312. The product stream 312 can include the renewable fuel product, a byproduct, and un-reacted hydrogen and non-combustible gas from the non-combustible gas feed 302 and the hydrogen gas feed 308. The product stream 312 can be fed to the heat exchanger 314, which can cool the product stream 312 and produce a cooled product stream 316. The cooled product stream 316 can be fed to the separator 318. The separator 318 can be a phase separator unit, which can separate the cooled product stream 316 into a gaseous mixture 319 and a liquid mixture 322 (e.g., a mixture of a liquid renewable fuel product and a liquid by-product). The gaseous mixture 319 can include un-reacted hydrogen and non-combustible gas from the non-combustible gas feed 302 and the hydrogen gas feed 308. The liquid mixture 322 can include any of the renewable fuel products discussed above, such as ammonia, methanol, other liquid hydrocarbon fuels, and the like. The renewable fuel product of the liquid mixture 322 can include a liquid product (e.g., liquid ammonia, liquid methanol, other liquid hydrocarbon fuels, or the like).

The reactor sub-system 331 can include the same or similar components to the reactor sub-system 311, and can perform the same or similar processes to produce the same or similar exit streams as the reactor sub-system 311. The reactor sub-system 331 can include the gaseous mixture 319 as a reactant (including un-reacted hydrogen and non-combustible gas), and can produce a liquid mixture 332 (e.g., a mixture of a liquid renewable fuel product and a liquid by-product) and a gaseous mixture 339 (including un-reacted hydrogen and non-combustible gas) as products.

The reactor 340 can convert the gaseous mixture 339 into a product stream 342. The product stream 342 can include the renewable fuel product and un-reacted hydrogen and non-combustible gas from the non-combustible gas feed 302 and the hydrogen gas feed 308 (e.g., that remains un-reacted after passing through the reactor sub-systems 311, 331). The product stream 342 can be fed to the heat exchanger 344, which can cool the product stream 342 and produce a cooled product stream 346. The cooled product stream 346 can be fed to the separator 348. The separator 348 can be a phase separator unit, which can separate the cooled product stream 346 into a gaseous mixture 349 and a liquid mixture 352 (e.g., a mixture of a liquid renewable fuel product and a liquid by-product). The gaseous mixture 349 can include un-reacted hydrogen and non-combustible gas from the non-combustible gas feed 302 and the hydrogen gas feed 308. The liquid mixture 352 can include any of the renewable fuel products discussed above, such as ammonia, methanol, other liquid hydrocarbon fuels, or the like. The renewable fuel product of the liquid mixture 352 can include a liquid product (e.g., liquid ammonia, liquid methanol, other liquid hydrocarbon fuels, or the like).

The liquid mixtures 322, 332, 352 can be separated from the gaseous mixtures 319, 339, 349 in each of the reactor sub-systems 311, 331, 341. This removes equilibrium limitations for un-reacted hydrogen and non-combustible gas in downstream reactors of the reactor system 300 (e.g., the reactor of the reactor sub-system 331 and the reactor 340) so that further conversion of the un-reacted reactants to product can occur in the downstream reactors.

The liquid mixtures 322, 332, 352 produced by the reactor sub-systems 311, 331, 341 can be fed to the buffer tank 361 coupled to the distillation column 368. The distillation column 368 can be used to separate the renewable fuel product 370 from liquid by-products included in the liquid mixtures 322, 332, 352, producing a liquid by-product stream 372. In some examples, the renewable fuel product 370 can include ammonia, methanol, other hydrocarbons, and the like. The liquid by-product stream 372 can include water or the like.

The gaseous mixture 349 can be fed to the burners 324, 354, 356 during both normal operation and when the reactor system 300 is in an idle state. The burners 324, 354, 356 can combust hydrogen in the gaseous mixture 349 (e.g., un-reacted hydrogen during normal operation) and can produce heat that can be used by the reactor system 300. Fractions of the gaseous mixture 349 can be sent to the burners 324, 354 and any burners of the reactor sub-system 331, and the flowrates of the fractions can be controlled or varied in order to provide desired pre-heat to the heat transfer fluids 360, 362, 364 entering the heat exchangers of the reactors 310, 340 and any reactors of the reactor sub-system 331. A remainder of the gaseous mixture 349 can be sent to the burner 356 to provide heat to a reboiler of the distillation column 368. For example, the heat can be used in an air separation unit to produce nitrogen, which can be included in the non-combustible gas feed 302. The heat can be used in a carbon dioxide capture system, a renewable fuel product distillation system, or the like.

The reactor system 300 can operate in an idle state for periods of time when power is low or not available from the renewable energy sources. For example, when power from the renewable energy sources decreases below a threshold value (e.g., when the hydrogen gas supply 304 or a forecast for the hydrogen gas supply 304 decreases below a threshold flowrate) and the amount of hydrogen in the upstream system storage decreases below a threshold value, the flowrate of the non-combustible gas feed 302 to the reactor 310 can be stopped. The flowrate of the hydrogen gas feed 308 to the reactor 310 can be minimized. Forecasts for renewable power production can be used to determine when to operate the reactor system 300 in the idle state in order to avoid depletion of the upstream system storage. In examples in which the reactor system 300 enters the idle state in response to the amount of hydrogen in the upstream system storage decreasing to the threshold value, the threshold value can be a value that allows for the reactor system 300 to operate in the idle state for a prescribed time period. In the idle state, hydrogen from the hydrogen gas feed 308 is directed to the reactors 310, 340 and any reactors of the reactor sub-system 331 and can be used to maintain an elevated pressure in the reactors 310, 340 and any reactors of the reactor sub-system 331. For example, the pressure of the reactors 310, 340 and any reactors of the reactor sub-system 331 can be maintained at or near a normal operating pressure. This ensures that any catalysts include in the reactors 310, 340, and any reactors of the reactor sub-system 331 are not exposed to outside air and prevents contamination of the catalysts, which reduces downtime and costs related to replacing the catalyst.

Hydrogen gas from the hydrogen gas feed 308 can pass through the reactor sub-systems 311, 331, 341 to the burners 324, 354, 356, and any burners of the reactor sub-system 331. The hydrogen gas can be combusted by the burners 324, 354, 356, and any burners of the reactor sub-system 331 in order to produce heat to maintain the reactor system 300 in the idle state for a period of time until renewable power becomes available again. In some examples, the burners 324, 354, and any burners of the reactor sub-system 331 can be omitted, and the burner 356 can be used to provide heat for the reactor system 300 when the reactor system 300 is in the normal operating state or the idle state. The flow of hydrogen from the hydrogen gas feed 308 to the burners 324, 354, 356, and any burners of the reactor sub-system 331 can be controlled to maintain the reactors 310, 340, any reactors of the reactor sub-system 331, the distillation column 368, and any other components of the reactor system 300 at or near (e.g., within about 50° C. of) normal operating temperatures. This reduces start-up times for resuming production of the renewable fuel product 370 by the reactor system 300 when power from the renewable energy sources becomes available again and the flowrate of the hydrogen gas supply 304 increases to a threshold value.

The reactions of equations 1-4, which are carried out in the reactors 310, 340, and any reactors of the reactor sub-system 331, can be performed at an elevated temperature and can be exothermic. As such, the reactors 310, 340, and any reactors of the reactor sub-system 331 can be pre-heated to initiate the reactions. The reactors 310, 340, and any reactors of the reactor sub-system 331 can be cooled during normal operation of the reactors 310, 340, and any reactors of the reactor sub-system 331 to remove heat generated by the reactions and avoid over-heating of the reactors 310, 340, and any reactors of the reactor sub-system 331. The distillation column 368 can be heated during normal operation. The reactors 310, 340, any reactors of the reactor sub-system 331, and the distillation column 368 can include heat exchangers through which heat transfer mediums 360, 362, 364, 366 travel. During normal operation of the reactor system 300, the heat transfer mediums 360, 362, 364, 366 can remove heat generated by the reactions in the reactors 310, 340, and any reactors of the reactor sub-system 331 and can supply heat to the distillation column 368. When the reactor system 300 is in the idle state, any combination of the burners 324, 354, 356, and any burners of the reactor sub-system 331 can heat the heat transfer mediums 360, 362, 364, 366 in order to maintain the reactors 310, 340, any reactors of the reactor sub-system 331, and the distillation column 368 at or near normal operating temperatures.

More specifically, the heat transfer mediums 362, 364, 366 entering the heat exchangers of the reactors 310, 340 and any reactors of the reactor sub-system 331 can include pressurized water that is at or near boiling in both the idle state and normal operation. During normal operation, the heat transfer mediums 362, 364, 366 boil as they passes through the heat exchangers of the reactors 310, 340 and any reactors of the reactor sub-system 331, removing heat from the reactors 310, 340 and any reactors of the reactor sub-system 331. During the idle state, the heat transfer mediums 362, 364, 366 maintain the reactors 310, 340 and any reactors of the reactor sub-system 331 at or near the normal operating temperatures.

The reboiler of the distillation column 368, the reactors 310, 340, and any reactors of the reactor sub-system 331 can be connected with one another in order to recycle heat through the reactor system 300. For example, under normal operation of the reactor system 300, a heat transfer medium 360 exiting the reboiler of the distillation column 368 can be used to cool the reactor 310. The heat transfer medium 360 can pick up heat from the reactor 310 and exit the reactor 310 as a heat transfer medium 362. The heat transfer medium 362 can be provided to any reactors of the reactor sub-system 331, and the heat transfer medium 362 can pick up heat from any reactors of the reactor sub-system 331 and exit the of the reactor sub-system 331 as a heat transfer medium 364. The heat transfer medium 364 can be provided to the reactor 340, and the heat transfer medium 364 can pick up heat from the reactor 340 and exit the reactor 340 as a heat transfer medium 366. Heat can be transferred from the heat transfer medium 366 to the reboiler of the distillation column 368 and the cooled heat transfer medium 360 can be passed back to the reactor 310. The burner 356 can provide an additional heat duty to the distillation column 368. In some examples, additional heat sources, such as electrical heating, can provide additional heating duties to the distillation column 368.

When the reactor system 300 operates in the idle state, the heat transfer mediums 360, 362, 364, 366 can be heated by the burners 324, 354, 356, and any burners of the reactor sub-system 331 to supply heat to the reactors 310, 340, any reactors of the reactor sub-system 331, and the distillation column 368. The burners 324, 354, 356, and any burners of the reactor sub-system 331 can combust the hydrogen from the gaseous mixture 352 passed through the reactors 310, 340, and any reactors of the reactor sub-system 331 for keeping the temperature of the reactors 310, 340, any reactors of the reactor sub-system 331, and the distillation column 368 at or near a normal operating temperature. This allows for processes used in the production of the renewable fuel product 370 to be readily resumed when renewable power becomes available and the reactor system 300 can move from the idle state back to normal operation.

In some examples, the heat transfer mediums 360, 362, 364, 366 included in the reactor system 300 can include pressurized boiling water. Pumps can be included to pressurize the heat transfer mediums 362, 364, 366 entering the reactor 310, any reactors of the reactor sub-system 331, and the reactor 340, respectively. The pressure of the heat transfer mediums 360, 362, 364 can be altered in order to vary the temperature of the heat transfer mediums 360, 362, 364, thereby controlling the temperatures of the reactors 310, 340 and any reactors of the reactor sub-system 331. In examples in which the heat transfer mediums 360, 362, 364, 366 include boiling water, the pressure of the heat transfer mediums 360, 362, 364 can be varied to vary the temperature at which water boils, thereby controlling temperature and heat transfer in the reactors 310, 340 and any reactors of the reactor sub-system 331.

The burners 324, 354, 356 can use any suitable oxidant (e.g., oxygen, air, or the like) for combusting the gaseous mixture 349. In some examples, oxygen can be used as the oxidant for the burners 324, 354, 356 combusting the gaseous mixture 349. Using oxygen can help to separate un-reacted non-combustible gas remaining in the gaseous mixture 349 from un-reacted hydrogen by burning all of the un-reacted hydrogen in the gaseous mixture 349. The un-reacted non-combustible gas (e.g., carbon dioxide, nitrogen, or the like) can then be returned and added to the non-combustible gas feed 302. In examples in which the hydrogen feed is produced by splitting water through renewable energy sources, the burners 324, 354, 356 can use oxygen obtained from the water splitting units that produce both hydrogen and oxygen.

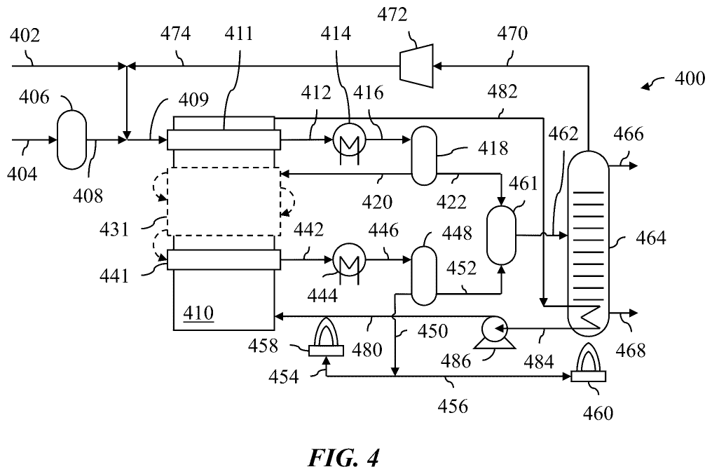

FIG. 4 illustrates a reactor system 400 that can be used in a dynamic operation for renewable fuel synthesis. The reactor system 400 can be used to produce renewable fuels, and can operate in conjunction with renewable energy sources. The reactor system 400 can be the same as or similar to the reactor system 300, except that the reactors 310, 340, and any reactors of the reactor sub-system 331 are replaced by a single reactor 410 including sub-reactors 411, 431, 441. The reactor 410 can have a single heat exchanger with a single feed or inlet for a heat transfer medium 480 that provides heating and/or cooling for the reactor 410. The heat exchanger of the reactor 410 can have a single outlet for a heat transfer medium 482 that has passed through the heat exchanger. Providing a single reactor 410 can simplify the heat transfer in the reactor system 400.

The reactor system 400 can convert a non-combustible gas feed 402 and a hydrogen supply 404 into a renewable fuel product 466. The reactor system 400 can include the reactor 410, which includes sub-reactors 411, 431, 441. Each of the sub-reactors 411, 431, 441 can be connected to a heat exchanger 414, 444 and a separator 418, 448. The sub-reactors 411, 431, 441 can be catalytic reactors. The reactor system 400 can include burners 458, 460, which can burn hydrogen gas passing through the reactor system 400, and can be used to supply heat to various components of the reactor system 400. The sub-reactor 431 can be the same as or similar to the sub-reactor 411, including the same or similar components to the sub-reactor 411. The sub-reactor 431 can include any number of repeating sub-reactors. Each of the sub-reactors in the sub-reactor 431 can be connected to a heat exchanger and a separator, which can be the same as or similar to the heat exchanger 414 and the separator 418, respectively. In some examples, the sub-reactor 431 can be optionally omitted. The sub-reactor 441 can be a last sub-reactor (e.g., a most downstream sub-reactor) of the reactor system 400. The separators 418, 448, and any separators connected to the sub-reactor 431 can be connected to a buffer tank 461 in fluid communication with a distillation column 464. The distillation column 464 can be used to separate the renewable fuel product 466 from liquid by-products 468. The heat exchanger 444 can be a last heat exchanger and the separator 448 can be a last separator.

The degree of conversion in each of the sub-reactors 411, 431, 441 depends on the temperature, pressure, catalyst activity, and other operating conditions of the respective sub-reactor 411, 431, 441. The number of sub-reactors included in the reactor 410 of the reactor system 400 can be selected depending on the specifics of the particular process performed in the reactor system 400. Generally, the number of sub-reactors 411, 431, 441 included in the reactor 410 can be selected to achieve a balance between an amount of hydrogen left in a gaseous mixture 450 exiting the separator 448 of the last sub-reactor 441 and heat duties of the processes carried out in the reactor system 400 that can be supplied by the burners 458, 460.

The reactor system 400 can include the non-combustible gas feed 402 and the hydrogen supply 404. The hydrogen gas supply 404 can be fed to a hydrogen buffer tank 406, which can buffer a variable input of the hydrogen supply 404. The hydrogen buffer tank 406 can provide a hydrogen gas feed 408 (also referred to as a buffered hydrogen gas feed). In the example of FIG. 4, the hydrogen gas feed 408 can be combined with the non-combustible gas feed 402 and a recycled gas feed 474 to produce a combined gas feed 409 that is fed to the reactor 410. In some examples, each of the hydrogen gas feed 408, the non-combustible gas feed 402, and the recycled gas feed 474 can be separately fed to the reactor 410.

The reactor 410 can convert the non-combustible gas and the hydrogen gas of the combined gas feed 409 into product streams 412, 442. More specifically, the sub-reactor 411 can produce the product stream 412 and the sub-reactor 441 can produce the product stream 442. The sub-reactor 431 can also produce a product stream, which can be the same as or similar to the product streams 412, 442. Each of the product streams 412, 442 can include the renewable fuel product, a byproduct, and un-reacted hydrogen and non-combustible gas from the combined gas feed 409. The product stream 412 can be fed to the heat exchanger 414, which can cool the product stream 412 and produce a cooled product stream 416. The cooled product stream 416 can be fed to the separator 418. The separator 418 can be a phase separator unit, which can separate the cooled product stream 416 into a gaseous mixture 420 and a liquid mixture 422 (e.g., a mixture of a liquid renewable fuel product and a liquid by-product). The gaseous mixture 420 can include un-reacted hydrogen and non-combustible gas from the combined gas feed 409. The liquid mixture 422 can include any of the renewable fuel products discussed above, such as ammonia, methanol, other liquid hydrocarbon fuels, synthetic oil, and the like. The renewable fuel product of the liquid mixture 422 can include a liquid product (e.g., liquid ammonia, liquid methanol, other liquid hydrocarbon fuels, or the like).

The sub-reactor 431 can include the same or similar components to the sub-reactor 411, and can perform the same or similar processes to produce the same or similar exit streams as the sub-reactor 411. For example, the sub-reactor 431 can include the gaseous mixture 420 as a reactant (including un-reacted hydrogen and non-combustible gas). The sub-reactor 431 can produce a liquid mixture (e.g., a mixture of a liquid renewable fuel product and a liquid by-product) that is combined with the liquid mixture 422. The sub-reactor 431 can further produce a gaseous mixture (including un-reacted hydrogen and non-combustible gas) that is fed to the sub-reactor 441.

The sub-reactor 441 can convert the gaseous mixture provided by the sub-reactor 431 into the product stream 442. The product stream 442 can include the renewable fuel product and un-reacted hydrogen and non-combustible gas from the combined gas feed 409 (e.g., that remains un-reacted after passing through the sub-reactors 411, 431). The product stream 442 can be fed to the heat exchanger 444, which can cool the product stream 442 and produce a cooled product stream 446. The cooled product stream 446 can be fed to the separator 448. The separator 448 can be a phase separator unit, which can separate the cooled product stream 446 into a gaseous mixture 450 and a liquid mixture 452 (e.g., a mixture of a liquid renewable fuel product and a liquid by-product). The gaseous mixture 450 can include un-reacted hydrogen and non-combustible gas from the combined gas feed 409. The liquid mixture 452 can include any of the renewable fuel products discussed above, such as ammonia, methanol, other liquid hydrocarbon fuels, or the like. The renewable fuel product of the liquid mixture 452 can include a liquid product (e.g., liquid ammonia, liquid methanol, other liquid hydrocarbon fuels, or the like). The liquid mixture 422, the liquid mixture 452, and the liquid mixture produced by the sub-reactor 431 can be combined to produce a combined liquid mixture 462. Specifically, the liquid mixture 422, the liquid mixture 452, and the liquid mixture produced by the sub-reactor 341 can be combined in the buffer tank 461, and the combined liquid mixture 462 can be fed from the buffer tank 461 to the distillation column 464.

The liquid mixtures 422, 452 and the liquid mixture produced by the sub-reactor 431 can be separated from the gaseous mixtures 420, 450, and the gaseous mixture produced by the sub-reactor 431 for each of the product streams 412, 442 and the product stream produced by the sub-reactor 431 exiting the sub-reactors 411, 431, 441. This removes equilibrium limitations for un-reacted hydrogen and non-combustible gas in downstream sub-reactors of the reactor 410 (e.g., the sub-reactor 431 and the sub-reactor 441) so that further conversion of the un-reacted reactants to product can occur in the downstream sub-reactors.

The liquid mixtures 422, 452 and the liquid mixture produced by the sub-reactor 431 can be fed to the distillation column 464. The distillation column 464 can be used to separate the renewable fuel product 466 from liquid by-products included in the liquid mixtures 422, 452 and the liquid mixture produced by the sub-reactor 431 producing liquid by-products 468. In some examples, the renewable fuel product 466 can include ammonia, methanol, other hydrocarbons, synthetic oil, and the like. The liquid by-products 468 can include water or the like.

As illustrated in FIG. 4, the liquid mixtures 422, 452 and the liquid mixture produced by the sub-reactor 431 can be fed to a buffer tank 461. The buffer tank 461 can buffer the combined liquid mixture 462 fed to the distillation column 464. For example, when the production of the liquid mixtures 422, 452 and the liquid mixture produced by the sub-reactor 431 is high, the buffer tank 461 can be filled and when the production of the liquid mixtures 422, 452 and the liquid mixture produced by the sub-reactor 431 is low, the buffer tank 461 can be emptied. Providing the buffer tank 461 can allow for the reactor 410 and the distillation column 464 to operate independently. For example, the distillation column 464 can operate even when production by the reactor 410 is low or stops, and the reactor 410 can operate even when separation by the distillation column 464 is low or stops.

In some examples in which the non-combustible gas feed 402 includes carbon dioxide, at least some of the carbon dioxide can be dissolved in the liquid mixtures 422, 452 and the liquid mixture produced by the sub-reactor 431. The distillation column 464 can separate this carbon dioxide from the liquid by-products 468 and the renewable fuel product 466, and the carbon dioxide can exit the distillation column 464 in a non-combustible gas stream 470. The non-combustible gas stream 470 can be pressurized by a compressor 472 to produce a recycled gas feed 474, which can be combined with the non-combustible gas feed 402, which is fed to the reactor 410. This allows for carbon dioxide dissolved in the liquid mixtures 422, 452 and the liquid mixture produced by the sub-reactor 431 to be recycled and utilized by the reactor system 400.

The gaseous mixture 450 can be fed to the burners 458, 460. The burners 458, 460 can combust un-reacted hydrogen in the gaseous mixture 450 and can produce heat that can be used by the reactor system 400. The burner 458 can supply heat to a heat transfer medium 480 that can provide heating to the reactor 410. The burner 460 can supply heat directly to the distillation column 464. In some examples, the burner 460 can supply heat to a heat transfer medium 482 that can provide heating to the distillation column 464, such as to a reboiler of the distillation column 464. The gaseous mixture 450 can be fed to the burner 458 and the burner 460 during both normal operation and when the reactor system 400 is in an idle state. A fraction 458 of the gaseous mixture 450 that is sent to the burner 454 can be controlled or varied in order to provide desired pre-heat to the heat transfer fluid 480 entering the heat exchanger of the reactor 410. A remainder 456 of the gaseous mixture 450 can be sent to the burner 460 to provide heat to the reboiler of the distillation column 464. When the reactor system 400 is in the idle state, the flowrate of the hydrogen gas feed 408 can be controlled or varied to provide sufficient heat by both the burner 458 and the burner 460 to maintain the reactor 410 and the distillation column 464 at or near normal operating temperatures. The gaseous mixture 450 can be provided to additional burners of the reactor system 400, such as an air separation unit (e.g., to produce nitrogen that can be included in the non-combustible gas feed 402), a carbon dioxide capture system, or the like.

The reactor system 400 can operate in the idle state for periods of time when power is not available from the renewable energy sources. For example, when power from the renewable energy sources decreases below a threshold value (e.g., when the hydrogen gas supply 404 or a forecast for the hydrogen gas supply 404 decreases below a threshold flowrate) and the amount of hydrogen in the upstream storage system decreases below a threshold value, the flowrate of the non-combustible gas feed 402 to the reactor 410 can be stopped. The flowrate of the hydrogen gas feed 408 to the reactor 410 can be minimized. The hydrogen gas feed 408 can be directed to the burners 458, 460 (e.g., through the sub-reactors 411, 431, 441). The hydrogen gas can be combusted by the burners 458, 460 in order to produce a sufficient amount of heat to maintain the reactor 410 and the distillation column 464, respectively, in the idle state for a period of time until renewable power becomes available again. In some examples, the burner 458 can be omitted, and the burner 460 can be used to provide heat for both the reactor 410 and the distillation column 464 when the reactor system 400 is in the normal operating state or the idle state. Any number of burners (e.g., a single burner, two burners, or more than two burners) can be used by the reactor system 400 to supply heat to the reactor 410, the distillation column 464, and any other components of the reactor system 400. The flow of hydrogen from the hydrogen gas feed 408 to the burners 458, 460 can be controlled to maintain the reactor 410, the distillation column 464, and any other components of the reactor system 400 at or near (e.g., within about 50° C. of) normal operating temperatures. This reduces start-up times for resuming production of the renewable fuel product 466 by the reactor system 400 when power from the renewable energy sources becomes available again and the flowrate of the hydrogen gas supply 404 increases to a threshold value. In the idle state, hydrogen from the hydrogen gas feed 408 can be further directed to the reactor 410. The hydrogen can be used to maintain an elevated pressure in the sub-reactors 411, 431, 441. For example, the pressure of the sub-reactors 411, 431, 441 can be maintained at or near a normal operating pressure. This ensures that any catalysts include in the reactor 410 are not exposed to outside air and prevents contamination of the catalysts, which reduces downtime and costs related to replacing the catalyst.

The reactions of equations 1-4, which are carried out in the reactor 410, can be performed at an elevated temperature and can be exothermic. As such, the reactor 410 can be pre-heated to initiate the reactions. The reactor 410 can be cooled during normal operation of the reactor 410 to remove heat generated by the reactions and avoid over-heating of the reactor 410. The distillation column 464 can be heated during normal operation. The reactor 410 and the distillation column 464 can include heat exchangers through which heat transfer mediums 480, 482, 484 travel. During normal operation of the reactor system 400, the heat transfer mediums 480, 482, 484 can remove heat generated by the reactions in the reactor 410 and can supply heat to the distillation column 464. When the reactor system 400 is in the idle state, the burners 458, 460 can heat the heat transfer mediums 480, 482 in order to maintain the reactor 410 and the distillation column 464 at or near normal operating temperatures. Specifically, the heat transfer fluid 480 can be pre-heated to at or near boiling by the burner 458 in both normal operation and the idle state of the reactor system 400. The heat transfer fluid 480 provides cooling to the sub-reactors 411, 431, 441 under normal operation and heating to the sub-reactors 411, 431, 441 in the idle state. The heat transfer fluid 482 exiting the reactor 410 is cooled by the reboiler of the distillation column 464, the cooled heat transfer fluid 484 exiting the distillation column 464 is pressurized to the heat transfer fluid 480, and the heat transfer fluid 480 is re-heated by the burner 458.

More specifically, the heat transfer medium 480 entering the heat exchanger of the reactor 410 can include water pressurized by the pump 486 that heated by the burner 458 to at or near boiling in both the idle state and normal operation. During normal operation, the heat transfer medium 480 boils as it passes through the heat exchanger of the reactor 410, removing heat from the reactor 410. During the idle state, the heat transfer medium 480 maintains the reactor 410 at or near the normal operating temperature.

The heat exchangers of the distillation column 464 and the reactor 410 can be connected with one another in order to recycle heat through the reactor system 400. For example, under normal operation of the reactor system 400, a heat transfer medium 484 exiting the heat exchanger of the distillation column 464 can be pumped by a pump 486 and the heat transfer medium 480 exiting the pump 486 can be used to cool the reactor 410. As described previously, the example of FIG. 4 can include a single reactor 410 with multiple sub-reactors 411, 431, 441, and a single heat transfer medium 480 can be used to provide heating and cooling for the reactor 410. After passing through the heat exchanger of the reactor 410, a heat transfer medium 482 that includes heat from the reactor 410 is passed back to the distillation column 464. The burner 460, which can supply heat to a reboiler of the distillation column 464, can provide an additional heating duty to the distillation column 464. In some examples, additional heating sources, such as electrical heating, can provide additional heating duties to the distillation column 464.

When the reactor system 400 operates in the idle state, the heat transfer medium 480 can be heated by the burner 458 to supply heat to the reactor 410. The burner 458 can combust a minimum hydrogen feed passed through the reactor 410 for keeping the temperature of the reactor 410 and the distillation column 464 at or near a normal operating temperature. This allows for processes used in the production of the renewable fuel product 466 to be readily resumed when renewable power becomes available and the reactor system 400 can move from the idle state back to normal operation.

In some examples, the heat transfer mediums 480, 482, 484 included in the reactor system 400 can include pressurized boiling water. The pressure of the heat transfer mediums 480, 482, 484 can be altered (e.g., by the pump 486) in order to vary the temperature of the heat transfer mediums 480, 482, 484, thereby controlling the temperature of the reactor 410. In examples in which the heat transfer mediums 480, 482, 484 include boiling water, the pressure of the heat transfer mediums 480, 482, 484 can be varied to vary the temperature at which water boils, thereby controlling temperature and heat transfer in the reactor 410.

The burners 458, 460 can use any suitable oxidant (e.g., oxygen, air, or the like) for combusting the gaseous mixture 450. In some examples, oxygen can be used as the oxidant for the burners 458, 460 combusting the gaseous mixture 450. Using oxygen can help to separate un-reacted non-combustible gas remaining in the gaseous mixture 450 from un-reacted hydrogen by burning all of the un-reacted hydrogen in the gaseous mixture 450. The un-reacted non-combustible gas (e.g., carbon dioxide, nitrogen, or the like) can then be returned and added to the non-combustible gas feed 402. In examples in which the hydrogen feed is produced by splitting water through renewable energy sources, the burners 458, 460 can use oxygen obtained from the water splitting units that produce both hydrogen and oxygen.

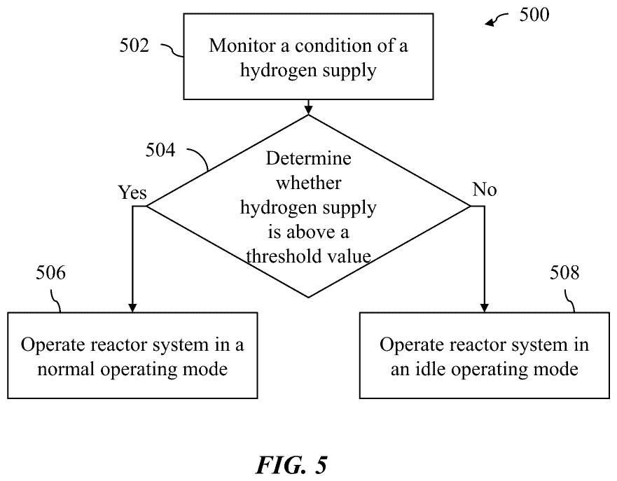

FIG. 5 shows a block diagram of a method 500 of operating a reactor system. The method 500 can be used with any of the reactor systems 100, 200, 300, 400 discussed above with respect to FIGS. 1 through 4. In block 502, a condition of a hydrogen supply to the reactor system is monitored. Because the hydrogen supply is provided using power from a renewable energy source, the hydrogen supply can be intermittent or fluctuating. The condition of the hydrogen supply can be monitored by monitoring power generated by the renewable energy source, forecasts related to expected power to be generated by the renewable energy source, a quantity of hydrogen stored in a hydrogen storage tank, combinations thereof, or the like. The renewable energy source can include a wind turbine, a photovoltaic solar panel, a geothermal generator, a hydroelectric generator, or any other renewable energy sources. Forecasts that can be monitored to determine expected power to be generated by the renewable energy source can include weather forecasts (e.g., forecasts for sunlight, wind, precipitation, and the like), snowpack levels, expected water flowrates, and any other forecasts relevant to production of power by the renewable energy source.

In block 504, a determination is made regarding whether the condition of the hydrogen supply is above a threshold value. The threshold value can be a value of power generated by the renewable energy source, expected power to be generated by the renewable energy source, a quantity of hydrogen stored in the hydrogen storage tank, or the like. The threshold values can be based on allowing the reactor system to operate in an idle operating mode for a minimum period of time, based on forecasts for expected power generation by the renewable energy source, or the like. If the determination of block 504 is yes and the condition of the hydrogen supply is above the threshold value, the reactor system operates in a normal operating mode in block 506. If the determination of block 504 is no and the condition of the hydrogen supply is not above the threshold value, the reactor system operates in the idle operating mode in block 508.

In block 506, the reactor system operates in the normal operating mode. As described above, the normal operating mode can include providing a non-combustible gas feed and a hydrogen feed to a reactor, reacting the non-combustible gas with the hydrogen to produce a renewable fuel product, and separating the renewable fuel product from any un-reacted non-combustible gas, un-reacted hydrogen, and by-products of the reaction. The hydrogen supply can be provided using power from a renewable energy source. The amount of power generated by the renewable energy source can fluctuate or be intermittent, such that the amount of the hydrogen supply can be varied, fluctuating, or intermittent. In the normal operating mode, a flowrate of hydrogen feed to a reactor can be controlled based on the state of the hydrogen supply, and a flowrate of the non-combustible gas can be varied proportionate to the flowrate of the hydrogen feed. Further, the reaction of the non-combustible gas with the hydrogen to produce the renewable fuel product can be exothermic. Thus, in the normal operating mode, cooling can be provided to the reactor in order to avoid the reactor over-heating.

In block 508, the reactor system is operated in the idle operating mode. In the idle operating mode, the flow of the non-combustible gas feed to the reactor system can be stopped and the flow of the hydrogen feed to the reactor system can be minimized. By passing hydrogen from the hydrogen feed through the reactor system, pressure can be maintained in any reactors of the reactor system and the hydrogen can be combusted by burners of the reactor system to maintain temperatures throughout the reactor system. Pressurizing the reactors with hydrogen prevents any catalysts included in the reactors from being exposed to air, which prevents contamination of the catalysts. This avoids the need to replace contaminated catalysts, reduces downtime, and reduces operating costs of the reactor system. Combusting hydrogen by the burners can be used to maintain components of the reactor system, such as reactors, distillation columns, and the like, at or near normal operating temperatures. This reduces the time and energy required to resume operating the reactor system in the normal operating mode. Providing the reactor system with the idle operating mode can reduce downtime for the reactor system, allow the reactor system to operate with a fluctuating or intermittent hydrogen feed (e.g., allowing the reactor system to function with hydrogen provided by renewable energy sources), and increase fuel production by the reactor system.

In some examples, the reactor system can transition from the normal operating mode of block 506 to the idle operating mode of block 508 in response to one or more of the power generated by the renewable energy source, the expected power to be generated by the renewable energy source, or the quantity of hydrogen stored in the hydrogen storage tank decreasing below a respective threshold value. The reactor system can transition from the idle operating mode of block 508 to the normal operating mode of block 506 in response to any combination of the power generated by the renewable energy source, the expected power to be generated by the renewable energy source, and the quantity of hydrogen stored in the hydrogen storage tank increasing above threshold values.

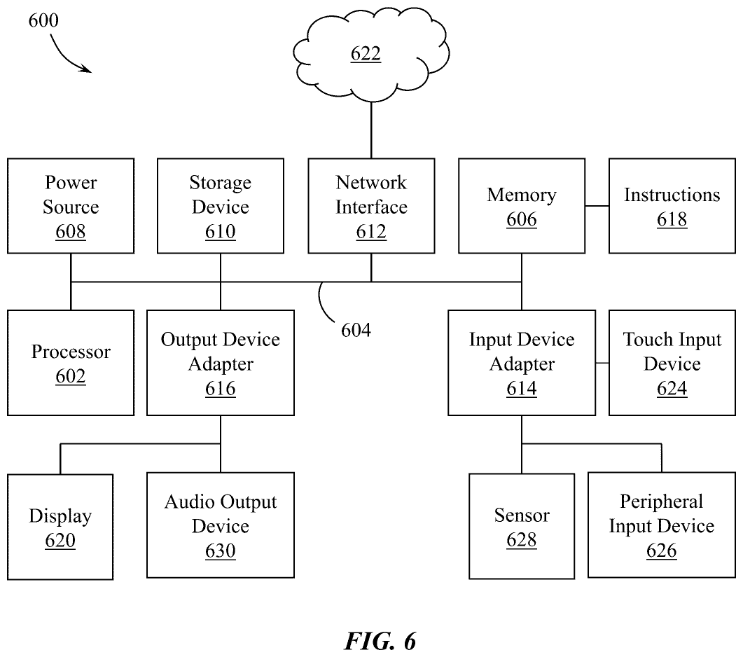

FIG. 6 shows a block diagram of a computing system 600 that can be used to implement embodiments of the present disclosure. In various embodiments, the computing system 600 can include various sets and subsets of the components shown in FIG. 6. Thus, FIG. 6 shows a variety of components that can be included in various combinations and subsets based on the operations and functions performed by the computing system 600 in different embodiments. For example, the computing system 600 can be part of the reactor systems 100, 200, 300, 400 discussed above with respect to FIGS. 1 through 4 and can be used to perform the method 500 described above with respect to FIG. 5. It is noted that, when described or recited herein, the use of the articles such as “a” or “an” is not considered to be limiting to only one, but instead is intended to mean one or more unless otherwise specifically noted herein.

The computing system 600 can include a central processing unit (CPU) or processor 602 connected via a bus 604 for electrical communication to a memory 606, a power source 608, an electronic storage device 610, a network interface 612, an input device adapter 614, and an output device adapter 616. One or more of these components can be connected to each other via a substrate (e.g., a printed circuit board or other substrate) supporting the bus 604 and other electrical connectors providing electrical communication between the components. The bus 604 can include a communication mechanism for communicating information between the components of the computing system 600.

The processor 602 can be a microprocessor or similar device configured to receive and execute a set of instructions 618 stored by the memory 606. The memory 606 can be referred to as a main memory, such as a random access memory (RAM) or another dynamic electronic storage device for storing information and instructions to be executed by the processor 602. The memory 606 can also be used for storing temporary variables or other intermediate information during execution of instructions by the processor 602. The processor 602 can include one or more processors or controllers, such as, for example, a CPU for the computing system 600 in general and a touch controller or similar sensor or I/O interface used for controlling and receiving signals from a display 620 and any other sensors being used (e.g., temperature, pressure, flowrate, and other sensors of the reactor systems 100, 200, 300, 400). The power source 608 can include a power supply capable of providing power to the processor 602 and other components connected to the bus 604, such as a connection to an electrical utility grid (e.g., a wired power supply) or a battery system.

The storage device 610 can include a read-only memory (ROM) or another type of static storage device coupled to the bus 604 for storing static or long-term (e.g., non-dynamic) information and instructions for the processor 602. For example, the storage device 610 can include a magnetic or optical disk (e.g., hard disk drive (HDD)), a solid state memory (e.g., a solid state disk (SSD)), or a comparable device.

The instructions 618 can include information for executing processes and methods using components of the computing system 600. Such processes and methods can include, for example, the methods described in connection with other embodiments elsewhere herein, including, for example, the methods and processes described in connection with FIGS. 1 through 5.

The network interface 612 can comprise an adapter for connecting the computing system 600 to an external device via a wired or wireless connection. For example, the network interface 612 can provide a connection to a computer network 622 such as a cellular network, the Internet, a local area network (LAN), a separate device capable of wireless communication with the network interface 612, other external devices or network locations, and combinations thereof. In one example embodiment, the network interface 612 is a wireless networking adapter configured to connect via WI-FI®, BLUETOOTH®, BLE, Bluetooth mesh, or a related wireless communications protocol to another device having interface capability using the same protocol. In some embodiments, a network device or set of network devices in the network 622 can be considered part of the computing system 600. In some cases, a network device can be considered connected to, but not a part of, the computing system 600.

The input device adapter 614 can be configured to provide the computing system 600 with connectivity to various input devices such as, for example, a touch input device 624, a peripheral input device 626, one or more sensors 628 (e.g., temperature, pressure, flowrate, and other sensors of the reactor systems 100, 200, 300, 400), related devices, and combinations thereof. The sensors 628 can be used to detect various characteristics of the components of the reactor systems 100, 200, 300, 400 and convert those phenomena to electrical signals. For example, the sensors 628 can include flowrate sensors that detect hydrogen, non-combustible gas, and product flowrates throughout the reactor systems 100, 200, 300, 400; pressure sensors that detect pressures in the reactors, heat exchangers, separators, and distillation columns of the reactor systems 100, 200, 300, 400; temperature sensors that detect temperatures of the burners, reactors, heat exchangers, separators, and distillation columns of the reactor systems 100, 200, 300, 400; and the like. The peripheral input device 626 (e.g., buttons, switches, dials, or the like) can be used to provide user input such as input regarding the settings of the computing system 600.

The output device adapter 616 can be configured to provide the computing system 600 with the ability to output information to a user, such as by providing visual output using one or more displays 620, by providing audible output using one or more speakers 630, or the like. Other output devices can also be used. The processor 602 can be configured to control the output device adapter 616 to provide information to a user via the output devices connected to the output device adapter 616. In some embodiments, the processor 602 and/or output device adapter 616 can be used to provide users with details regarding an operating status of the reactor systems 100, 200, 300, 400, renewable energy sources connected to the reactor systems 100, 200, 300, 400, and the like.

Other examples and implementations are within the scope and spirit of the disclosure and appended claims. For example, features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and Band C). Further, the term “exemplary” does not mean that the described example is preferred or better than other examples.

The foregoing description, for purposes of explanation, uses specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art that many modifications and variations are possible in view of the above teachings.

What is claimed is:

1. A reactor system comprising:
a variable feed of non-combustible gas;
an intermittent hydrogen supply coupled to a hydrogen gas buffer, the hydrogen gas buffer providing a variable feed of hydrogen gas;
a reactor coupled to the variable feed of non-combustible gas and the variable feed of hydrogen gas, the reactor configured to convert the non-combustible gas and the hydrogen gas into a renewable fuel product, the reactor comprising an internal heat exchanger configured to provide cooling to the reactor in a normal operating mode and to provide heating to the reactor in an idle mode;
a heat exchanger coupled to an outlet of the reactor;
a phase separator coupled to an outlet of the heat exchanger, wherein the phase separator is configured to separate a gas stream comprising un-reacted hydrogen and un-reacted non-combustible gas from a liquid stream comprising the renewable fuel product; and
a burner configured to combust the un-reacted hydrogen contained in the gas stream.

2. The reactor system of claim 1, further comprising:
a last reactor coupled to the gas stream exiting the phase separator;
a last heat exchanger coupled to an outlet of the last reactor; and
a last phase separator coupled to an outlet of the last heat exchanger, wherein the last phase separator is configured to separate a last gas stream comprising un-reacted hydrogen and un-reacted non-combustible gas from a last liquid stream, wherein the burner is further configured to combust the un-reacted hydrogen contained in the last gas stream.

3. The reactor system of claim 2, further comprising:
a buffer tank coupled to collect the liquid stream and the last liquid stream; and
a distillation column coupled to the buffer tank, wherein:
the distillation column is configured to separate the renewable fuel product from by-products;
the internal heat exchanger and a last internal heat exchanger of the last reactor are coupled to a reboiler of the distillation column; and
a heat transfer fluid flows through the internal heat exchanger, the last internal heat exchanger, and the reboiler.

4. The reactor system of claim 3, wherein the burner is configured to supply heat to the reboiler of the distillation column and to the heat transfer fluid entering the internal heat exchanger of the reactor and entering the last internal heat exchanger of the last reactor.

5. The reactor system of claim 3, wherein the heat transfer fluid comprises pressurized boiling water.

6. The reactor system of claim 3, wherein:
the distillation column is further configured to separate a non-combustible gas stream dissolved in the liquid stream from the renewable fuel product and the by-products; and
the reactor system further comprises a compressor configured to recycle the non-combustible gas stream to the variable feed of non-combustible gas.

7. The reactor system of claim 2, wherein the variable feed of non-combustible gas and the hydrogen gas buffer contain gases at pressures above an operating pressure of the reactor.

8. The reactor system of claim 2, wherein the variable feed of non-combustible gas comprises nitrogen and the renewable fuel product comprises ammonia.

9. The reactor system of claim 2, wherein the variable feed of non-combustible gas comprises carbon dioxide and the renewable fuel product comprises methanol.

10. A method comprising:
monitoring a condition of a hydrogen supply;
in response to the condition of the hydrogen supply being greater than a threshold value, operating a reactor system in a normal operating mode wherein:
a hydrogen feed rate and a non-combustible gas feed rate to a reactor are varied based on the condition of the hydrogen supply; and
in response to the condition of the hydrogen supply being less than the threshold value, operating the reactor system in an idle mode wherein:
the hydrogen feed rate to the reactor is reduced to a minimum value; and
the non-combustible gas feed rate to the reactor is stopped.

11. The method of claim 10, wherein the condition of hydrogen supply comprises at least one of power generated by a renewable energy source, a forecast for power generated by the renewable energy source, or a quantity of hydrogen in a hydrogen gas storage of the reactor system.

12. The method of claim 10, wherein operating the reactor system in the idle mode further comprises combusting hydrogen from the hydrogen feed after passing the hydrogen through the reactor.

13. The method of claim 10, wherein the minimum value of the hydrogen feed rate in the idle mode is controlled to provide sufficient heat from combusting the hydrogen to maintain temperatures of the reactor and a distillation column at or near normal operating temperatures.

14. A reactor system comprising:
a controllable non-combustible gas feed;
an intermittent hydrogen supply coupled to a hydrogen gas buffer, the hydrogen gas buffer providing a controllable hydrogen gas feed;
a heat exchange reactor comprising:
a plurality of catalytic stages;
an inlet and an outlet for a heat transfer fluid, the heat transfer fluid configured to provide cooling to the catalytic stages in a normal operating mode and to provide heating to the catalytic stages in an idle mode;
a first catalytic stage of the catalytic stages coupled to the non-combustible gas feed and the hydrogen gas feed, the first catalytic stage being thermally coupled to the heat transfer fluid, the first catalytic stage being configured to convert non-combustible gas of the non-combustible gas feed and hydrogen gas of the hydrogen gas feed into a renewable fuel product; and
a last catalytic stage of the catalytic stages coupled to a gas stream exiting a phase separator coupled to one of the catalytic stages, the last catalytic stage being thermally coupled to the heat transfer fluid, the last catalytic stage being configured to convert the gas stream into the renewable fuel product;
a last phase separator coupled to an outlet of the last catalytic stage, the last phase separator being configured to separate a last gas stream comprising un-reacted hydrogen and un-reacted non-combustible gas from a last liquid stream comprising the renewable fuel product; and
a burner configured to combust the un-reacted hydrogen contained in the last gas stream.

15. The reactor system of claim 14, further comprising:
a first heat exchanger coupled to an outlet of the first catalytic stage;
a first phase separator coupled to an outlet of the first heat exchanger, the first phase separator being configured to separate a first gas stream from a first liquid stream;
a buffer tank coupled to the first liquid stream and the last liquid stream; and
a distillation column coupled to the buffer tank, wherein the distillation column is configured to separate the renewable fuel product from a liquid by-product.

16. The reactor system of claim 15, wherein:
the burner is configured to supply heat to the heat transfer fluid entering the heat exchange reactor and to a reboiler of the distillation column; and
the outlet for the heat transfer fluid of the heat exchange reactor is coupled to an inlet of a reboiler of the distillation column.

17. The reactor system of claim 15, wherein the heat transfer fluid comprises pressurized boiling water.

18. The reactor system of claim 15, wherein:
the distillation column is further configured to separate un-reacted non-combustible gas dissolved in the first liquid stream and the last liquid stream from the renewable fuel product and the liquid by-product; and
the reactor system further comprises a compressor configured to recycle the un-reacted non-combustible gas from the distillation column to the non-combustible gas feed.

19. The reactor system of claim 15 wherein the non-combustible gas feed and the hydrogen gas buffer contain gases at pressures above an operating pressure of the catalytic stages of the heat exchange reactor.

20. The reactor system of claim 15, wherein the non-combustible gas feed comprises carbon dioxide and the renewable fuel product comprises methanol.
